(19) United States
(12) Patent Application Publication
(10) Pub. No.: US 2007/0147451 A1
(43) Pub. Date: Jun. 28, 2007

(54) Laser diode driver

(75) Inventor: Makoto Sakaguchi, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/637,799

(22) Filed: Dec. 13, 2006

(30) Foreign Application Priority Data
Dec. 22, 2005 (JP) 2005-370324

(51) Int. Cl. H01S 3/00

(52) U.S. Cl. 372/38.02; 372/38.07

(57) ABSTRACT

There is provided a laser diode driver including a DC current source supplying DC current to a laser diode, and a plurality of high frequency current sources alternately superposing onto the DC current high frequency current of the same polarity as the DC current and high frequency current of an opposite polarity to the DC current. The high frequency current of the opposite polarity is smaller than the high frequency current of the same polarity.

### BACKGROUND OF THE INVENTION

1. Field of the Invention

The present invention relates to a driver for a laser diode which is used as a light source for data reading, erasing, and writing on CD (Compact Disc), DVD (Digital Versatile Disc) and so on.

2. Description of Related Art

A laser diode which is used for an optical disc such as CD or DVD is driven using DC current in each of read, erase, and write periods as shown in FIG. 7 which illustrates a rewritable optical disc as an example. If the light from the laser diode is reflected on a disc surface to return to enter the laser diode, oscillation becomes unstable to cause noise to occur. To avoid this, as shown in FIG. 8, there is a technique of superposing high frequency current of several 100 MHz on DC current to change the oscillation mode of the laser diode from a single-mode to a multi-mode to thereby reduce the effect of noise. The superposition of the high frequency current is performed typically during the read period. It may be performed during the read and erase periods as shown in FIG. 8, or even during the write period. Further, the superposition of the high frequency current may be performed during a certain period only when focus servo or tracking servo becomes unstable. This is thus the essential feature for a laser diode driver.

As shown in the schematic circuit diagram of FIG. 9, a laser diode driver of a related art includes an APC circuit which supplies DC current I1 to the anode of a laser diode LD so as to maintain a constant light output from the laser diode LD by feeding back the output from a photoreceptor PD which receives light from the laser diode LD, a source-side high frequency current source 201 and a first switching element 203 which are connected in series between a power supply voltage VDD and the anode of the laser diode LD, a second switching element 204 and a sink-side high frequency current source 202 which are connected in series between the anode of the laser diode LD and a ground voltage, a logic circuit which is activated by a high frequency ON/OFF signal and alternately turns ON and OFF the first switching element 203 and the second switching element 204 according to the high frequency signal, and an amplitude regulator which sets high frequency current I2 for the source-side high frequency current source 201 and the sink-side high frequency current source 202.

In the circuit of FIG. 9, when high frequency current is not superposed, the first switching element 203 and the second switching element 204 are both OFF. Thus, as shown in FIG. 10, the DC current I1 which is supplied from the APC circuit I1 flows as laser diode drive current I4 to the laser diode LD. On the other hand, when high frequency current is superposed, gate voltages S1 and S2 are applied to the gates of the first switching element 203 and the second switching element 204 so that the first switching element 203 and the second switching element 204 alternately turn ON and OFF. Thus, if the first switching element 203 turns ON, the current in which the high frequency current I2 is added to the DC current I1 flows as the laser diode drive current I4. If, on the other hand, the second switching element 204 turns ON, the current in which the high frequency current I2 is subtracted from the DC current I1 flows as the laser diode drive current I4, as shown in FIG. 10. This is disclosed in Japanese Patent No. 3708767.

FIG. 11 shows the state where the laser diode LD is driven when high frequency current is superposed. In the graph of FIG. 11, F indicates light output characteristics, P indicates light output waveform, and Ith indicates threshold current. If the laser diode drive current I4 falls below the threshold current Ith, the light output P becomes 0 and the oscillation of the laser diode LD stops. If the laser diode drive current I4 exceeds the threshold current Ith, the laser diode LD starts the oscillation and the light output P is obtained. The intermittent oscillation of the laser diode allows the above-described multi-mode to likely to occur and thereby reduces the noise caused by return light. In order to perform such operation, it is necessary to set the DC component (the DC current I1) of the laser diode drive current I4 to the level close to the threshold current Ith. However, due to the varying optical characteristics of the laser diode, the laser diode unnecessarily emits light or unnecessary DC current flows when the high frequency current is not superposed. One approach is setting the laser diode drive current to 0 during the non-superposition. In such a case, however, the DC current I1 flows abruptly at the start of the superposition operation to cause the generation of high harmonic.

A laser diode driver according to another related art aims to solve the above drawbacks. As shown in FIG. 12, the laser diode driver includes a first current setting circuit 10 which sets DC current I1 supplied from a DC current source 101 to the laser diode LD, the source-side high frequency current source 201 and the first switching element 203 which are connected in series between the power supply voltage VDD and the anode of the laser diode LD, the second switching element 204 and the sink-side high frequency current source 202 which are connected in series between the anode of the laser diode LD and the ground voltage, a superposition controller 21 which is activated by a signal to a superposition control terminal T1 and alternately turns ON and OFF the first switching element 203 and the second switching element 204 according to the high frequency signal from an oscillator OSC, and a second current setting circuit 20 which sets high frequency current I2 for the source-side high frequency current source 201 and the sink-side high frequency current source 202. Further, the laser diode driver includes an additional current source 301 and a third switching element 205 which are connected in series between the power supply voltage VDD and the anode of the laser diode LD, and a third current setting circuit 30 which sets additional current I3 of the additional current source 301. This laser diode driver is different from a conventional laser diode driver in that the additional current source 301, the third switching element 205, and the third current setting circuit 30 are provided.

In the circuit of FIG. 12, when high frequency current is not superposed, the first switching element 203, the second switching element 204, and the third switching element 205 are all OFF. Thus, as shown in FIG. 13, the DC current I1 which is supplied from the DC current source 101 flows as the laser diode drive current I4 to the laser diode LD. On the other hand, when high frequency current is superposed, the third switching element 205 is ON and thereby the DC current I1 which is supplied from the DC current source 101 and further the additional current I3 which is supplied from the additional current source 301 flows to the laser diode. Further, the gate voltages S1 and S2 are applied to the gates of the first switching element 203 and the second switching element 204, so that the first switching element 203 and the second switching element 204 alternately turn ON and OFF. Thus, if the first switching element 203 turns ON, the current in which the additional current I3 and the high frequency current I2 are added to the DC current I1 flows as the laser diode drive current I4. If, on the other hand, the second switching element 204 turns ON, the current in which the high frequency current I2 is subtracted from a sum of the DC current I1 and the additional current I3 flows as the laser diode drive current I4, as shown in FIG. 13.

Consequently, the laser diode driver described with reference to FIGS. 12 and 13 can reduce the current flowing to the laser diode from I1+I3 to I1 during the operation where the high frequency current is not superposed, so that the current I1 can be set sufficiently smaller than the threshold current Ith. This overcomes the drawbacks that the laser diode unnecessarily emits light or unnecessary DC current flows when the high frequency current is not superposed due to the varying optical characteristics of the laser diode.

However, the laser diode drivers shown in FIGS. 9 and 12 have common problems to be solved. When the second switching element 204 is ON, the high frequency current I2 which flows into the ground through the sink-side high frequency current source 202 of the opposite polarity to the current polarity of the DC current I1 is useless current which does not contribute to the emission of the laser diode LD. This increases power consumption of the laser diode driver to cause excessive heating. In FIGS. 10 and 13, the portion indicated by the oblique line corresponds to the useless electric power which does not contribute to the emission of the laser diode LD.

Accordingly, a laser diode driver which minimizes the high frequency current flowing to the ground through the sink-side high frequency current source of the opposite polarity to the DC current to thereby reduce the power consumption of the laser diode driver and maintain moderate heating is demanded.

### SUMMARY OF THE INVENTION

According to an aspect of the present invention, there is provided a laser diode driver including a DC current source supplying DC current to a laser diode, and a plurality of high frequency current sources alternately superposing onto the DC current high frequency current of the same polarity as the DC current and high frequency current of an opposite polarity to the DC current, wherein the high frequency current of the opposite polarity is smaller than the high frequency current of the same polarity.

According to the laser diode driver of the aspect of the present invention, when superposing the high frequency current, the high frequency current of the opposite polarity can be smaller than the high frequency current of the same polarity. Thus, on condition that the amplitude of the high frequency current is the same, the high frequency current flowing into the ground through the sink-side high frequency current source of the opposite polarity to the DC current can be reduced, thereby providing the advantages of reducing the power consumption and suppressing the heating in the laser diode driver.

### BRIEF DESCRIPTION OF THE DRAWINGS

The above and other objects, advantages and features of the present invention will be more apparent from the following description taken in conjunction with the accompanying drawings, in which:

FIG. 1 is a circuit block diagram showing a laser diode driver according to a first embodiment of the present invention;

FIG. 2 is a detailed circuit diagram showing the laser diode driver according to the first embodiment of the present invention;

FIG. 3 is a view to describe the operation of the laser diode driver according to the first embodiment of the present invention;

FIG. 4 is a circuit block diagram showing a laser diode driver according to a second embodiment of the present invention;

FIG. 5 is a detailed circuit diagram showing the laser diode driver according to the second embodiment of the present invention;

FIG. 6 is a view to describe the operation of the laser diode driver according to the second embodiment of the present invention;

FIG. 7 is a view to describe the drive current of a laser diode;

FIG. 8 is a view to describe the drive current of a laser diode onto which high frequency current is superposed;

FIG. 9 is a circuit diagram (substantial part) showing a laser diode driver according to a related art;

FIG. 10 is a view to describe the operation of a laser diode driver according to a related art;

FIG. 11 is a view to describe the relationship between the drive current of a laser diode and light output;

FIG. 12 is a circuit diagram showing another laser diode driver according to a related art; and

FIG. 13 is a view to describe the operation of another laser diode driver according to a related art.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Exemplary embodiments of the present invention are described hereinafter with reference to the accompanying drawings. In the drawings, the same elements as those described in the related art are denoted by the same reference numerals.

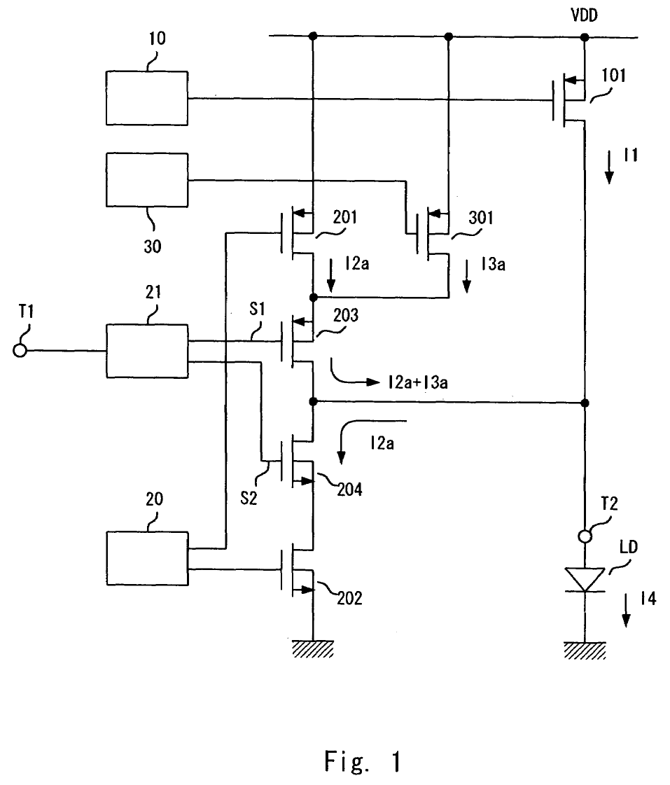

Referring first to FIG. 1, a laser diode driver according to a first embodiment of the present invention includes a DC current source 101, a first current setting circuit 10 which sets the current of the DC current source 101, a source-side high frequency current source 201, a sink-side high frequency current source 202, a second current setting circuit 20 which sets the current of the source-side high frequency current source 201 and the sink-side high frequency current source 202, a first switching element 203, a second switching element 204, a superposition controller 21 which turns ON/OFF the first switching element 203 and the second switching element 204, an additional current source 301 connected in parallel with the source-side high frequency current source 201, and a third current setting circuit 30 which sets the current of the additional current source 301. The first embodiment of the present invention characteristically includes the additional current source 301 connected in parallel with the source-side high frequency current source 201 and the third current setting circuit 30 which sets the current of the additional current source 301.

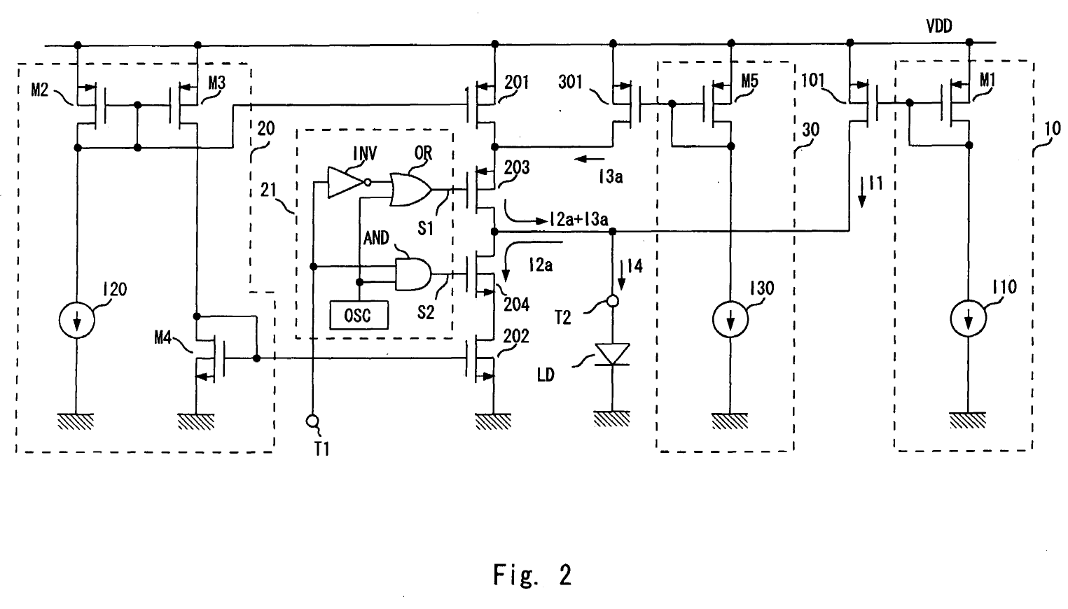

Referring next to FIG. 2 showing a detailed example of the circuit of FIG. 1, the configuration of the laser diode driver is described below. The source and the drain of the DC current source 101, which is formed of a PMOS transistor, are connected to a power supply voltage VDD and an output terminal T2, respectively. The first current setting circuit 10 includes a PMOS transistor M1 which forms a current mirror with the DC current source 101, and a current source 110. The source of the PMOS transistor M1 is connected to the power supply voltage VDD, and the gate and the drain of the PMOS transistor M1 are connected to the gate of the DC current source 101 and one end of the current source 110. The other end of the current source 110 is connected to the ground.

The source and the drain of the source-side high frequency current source 201, which is formed of a PMOS transistor, are connected to the power supply voltage VDD and the source of the first switching element 203, respectively. The source and the drain of the sink-side high frequency current source 202, which is formed of an NMOS transistor, are connected to the ground and the source of the second switching element 204, respectively. The second current setting circuit 20 includes PMOS transistors M2 and M3 which form a current mirror with the source-side high frequency current source 201, a current source I20, and an NMOS transistor M4. The source of the PMOS transistor M2 is connected to the power supply voltage VDD, and the gate and the drain of the PMOS transistor M2 are connected to the gate of the PMOS transistor M3, the gate of the source-side high frequency current source 201, and one end of the current source I20. The other end of the current source I20 is connected to the ground. The source of the PMOS transistor M3 is connected to the power supply voltage VDD, and the drain of the PMOS transistor M3 is connected to the drain and the gate of the NMOS transistor M4 and the gate of the sink-side high frequency current source 202. The source of the NMOS transistor M4 is connected to the ground.

The source and the drain of the additional current source 301, which is formed of a PMOS transistor, are connected to the power supply voltage VDD and the drain of the source-side high frequency current source 201, respectively. The third current setting circuit 30 includes a PMOS transistor M5 which forms a current mirror with the additional current source 301, and a current source 130. The source of the PMOS transistor M5 is connected to the power supply voltage VDD, and the gate and the drain of the PMOS transistor M5 are connected to the gate of the additional current source 301 and one end of the current source 130. The other end of the current source 130 is connected to the ground.

The superposition controller 21 includes an oscillator OSC, an inverter INV, an OR circuit OR, and an AND circuit AND. The input terminal of the inverter INV is connected to a superposition control terminal T1 and one input terminal of the AND circuit AND. The output terminal of the inverter INV is connected to one input terminal of the OR circuit OR. The output of the oscillator OSC is connected to the other input terminal of the OR circuit OR and the other input terminal of the AND circuit AND. The output of the OR circuit OR and the output of the AND circuit AND are respectively connected to the gate of the first switching element 203 and the gate of the second switching element 204.

The drain of the first switching element 203 which is formed of a PMOS transistor is connected to the drain of the second switching element 204 which is formed of an NMOS transistor and the output terminal T2. The output terminal T2 is connected to the anode of the laser diode LD which serves as a load. The cathode of the laser diode LD is grounded.

The laser diode driver of the first embodiment of the present invention has the characteristic feature of eliminating the third switching element 205 of the above-described laser diode driver shown in FIG. 12 and connecting the drain of the additional current source 301 to the drain of the source-side high frequency current source 201.

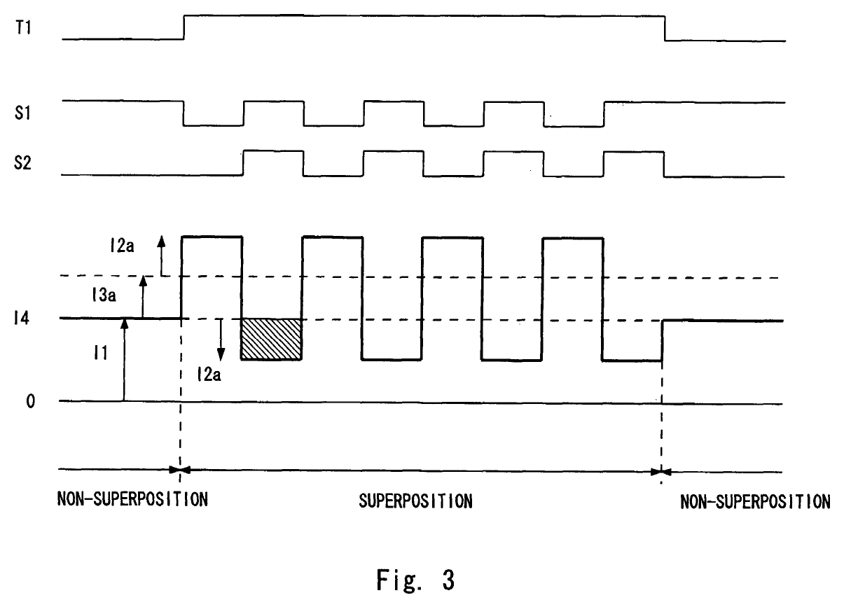

Referring then to FIGS. 2 and 3, the operation of the laser diode driver of this embodiment is described hereinbelow. When the superposition control terminal T1 is Low level (hereinafter referred to as L level), one input terminal of the OR circuit OR is High level (hereinafter referred to as H level), and the output of the OR circuit OR is H level regardless of the output level of the oscillator OSC. Accordingly, the first switching element 203 formed of a PMOS transistor is OFF. Further, the L level of the superposition control terminal T1 is input to one input terminal of the AND circuit AND, and therefore the output of the AND circuit AND is L level regardless of the output level of the oscillator OSC. Accordingly, the second switching element 204 formed of an NMOS transistor is also OFF. In the operation where the high frequency current is not superposed, the DC current I1 in which the current flowing through the current source 110 is multiplied by the mirror ratio of the PMOS transistor M1 and the DC current source 101 is output from the output terminal T2.

On the other hand, when the superposition control terminal T1 is H level, one input terminal of the OR circuit OR is L level, and the output of the OR circuit OR repeats H/L in phase with the output level of the oscillator OSC. Accordingly, the first switching element 203 formed of a PMOS transistor which receives the output of the oscillator OSC as the gate voltage S1 repeats OFF/ON. Further, the H level of the superposition control terminal T1 is input to one input terminal of the AND circuit AND, and therefore the output of the AND circuit AND repeats H/L in phase with the output level of the oscillator OSC. Accordingly, the second switching element 204 formed of an NMOS transistor which receives the output of the oscillator OSC as the gate voltage S2 repeats ON/OFF. In this manner, the first switching element 203 and the second switching element 204 alternately repeat ON and OFF.

When the first switching element 203 is ON, a sum of high frequency current I2a in which the current flowing through the current source I20 is multiplied by the mirror ratio of the PMOS transistor M2 and the source-side high frequency current source 201, additional current I3a in which the current flowing through the current source I30 is multiplied by the mirror ratio of the PMOS transistor M5 and the additional current source 301, and the DC current I1 is output from the output terminal T2. On the other hand, when the second switching element 204 is ON, the current in which the high frequency current I2a in which the current flowing through the current source I20 is multiplied by the mirror ratio of the PMOS transistor M2 and the PMOS transistor M3 and further multiplied by the mirror ratio of the NMOS transistor M4 and the sink-side high frequency current source 202 is subtracted from the DC current I1 is output from the output terminal T2. Accordingly, in the operation where the high frequency current is superposed, the DC current I1, a sum of the high frequency current I2a on the source-side side additional current I3a, and the current in which the high frequency current I2a on the sink-side side is subtracted from the DC current I1 are alternately output from the output terminal T2.

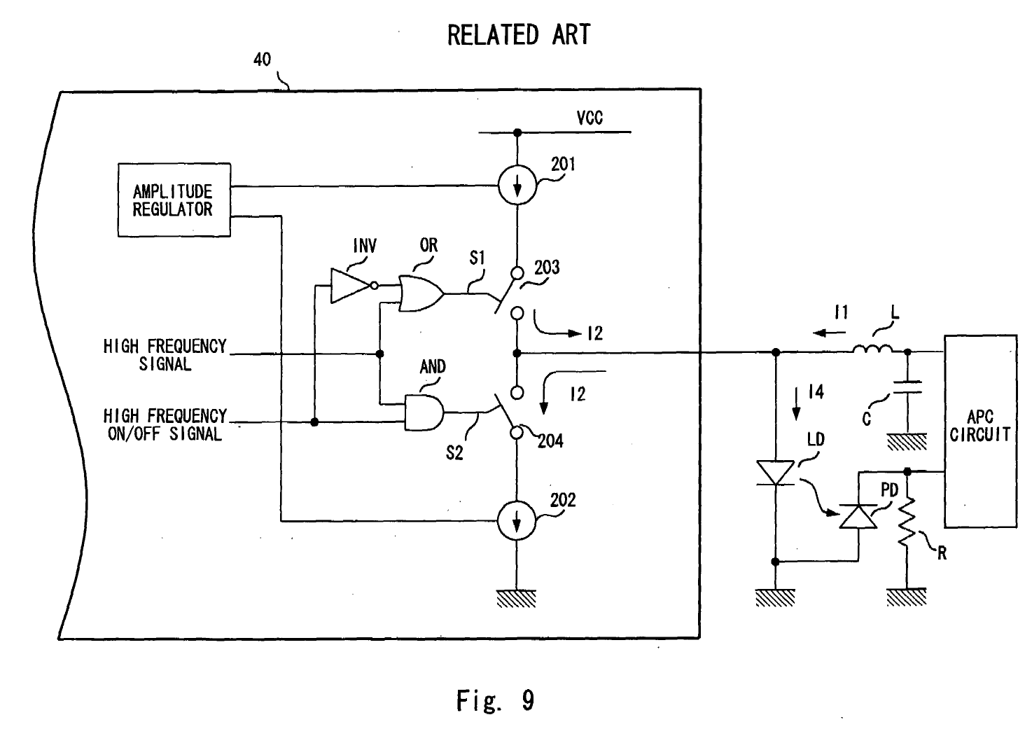

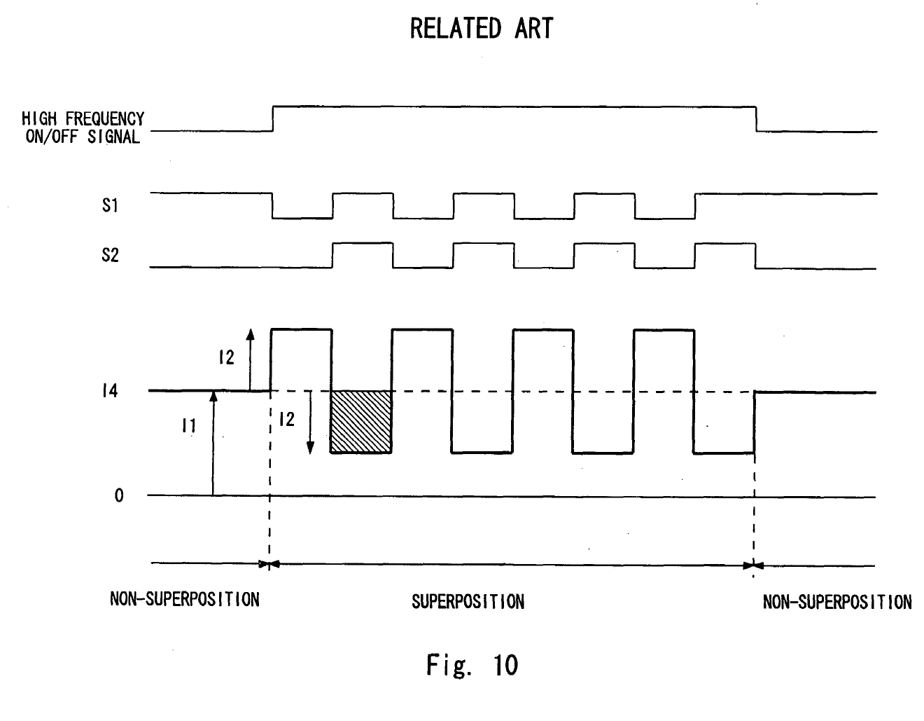

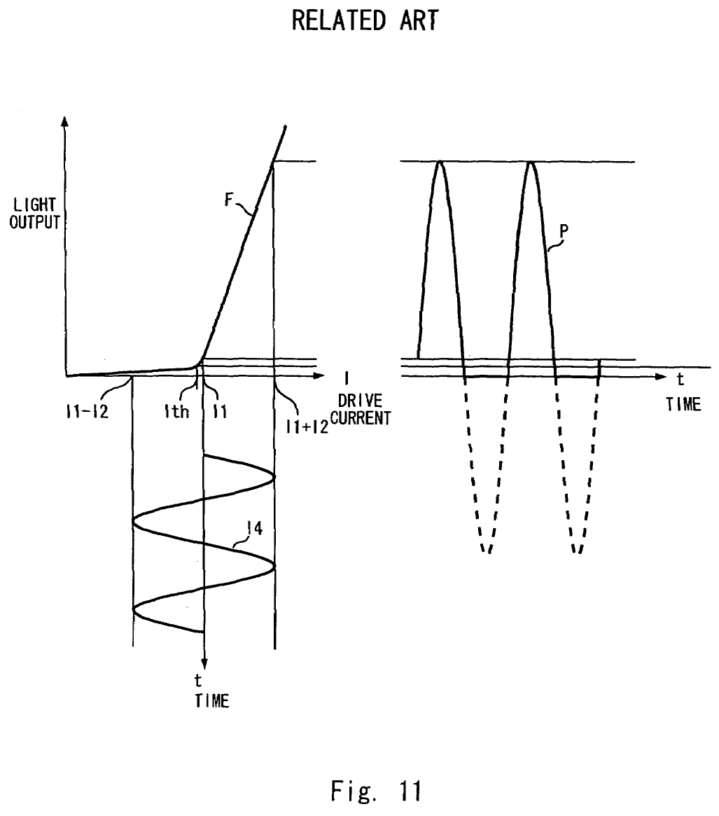

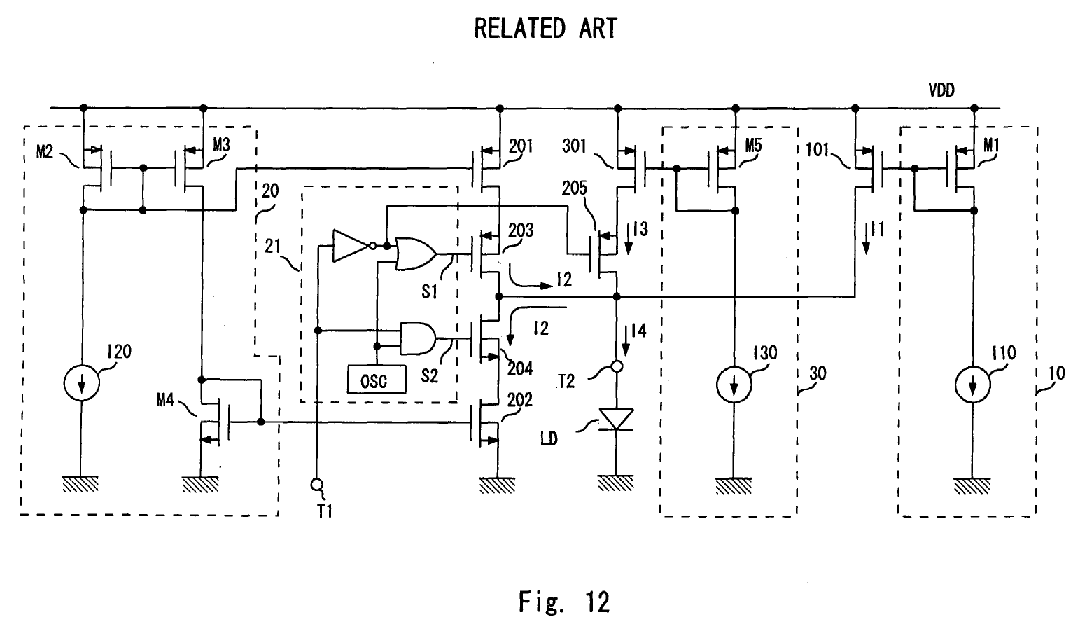

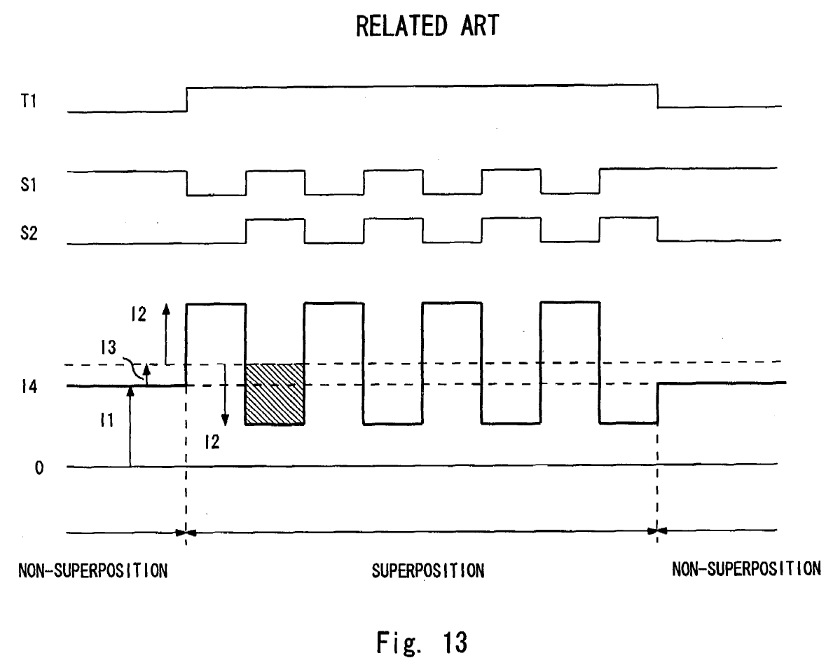

In FIG. 3, the portion corresponding to the useless electric power which does not contribute to the emission of the laser diode LD is indicated by the oblique line. The high frequency current I2a which flows to the ground through the sink-side high frequency current source of the opposite polarity to the current polarity of the DC current can be smaller by ½ of the additional current I3a than that in the laser diode driver described with reference to FIGS. 9 and 12 on condition that the amplitude of the entire high frequency current is the same. This enables the reduction of the useless electric power which does not contribute to the emission of the laser diode LD.

The laser diode driver of this embodiment includes the additional current source 301 connected in parallel with the source-side high frequency current source 201 and the third current setting circuit 30 for setting the current of the additional current source 301. In this configuration, the laser diode driver including a DC current source for supplying DC current to the laser diode and a plurality of high frequency current sources for alternately superposing the high frequency current of the same polarity as the DC current and the high frequency current of the opposite polarity to the DC current onto the DC current enables the high frequency current of the opposite polarity to be smaller than the high frequency current of the same polarity. Consequently, if the amplitude of the high frequency current is the same, the high frequency current flowing to the ground through the sink-side high frequency current source of the opposite polarity to the DC current can be reduced, thereby providing the advantages of reducing the power consumption and suppressing the heating.

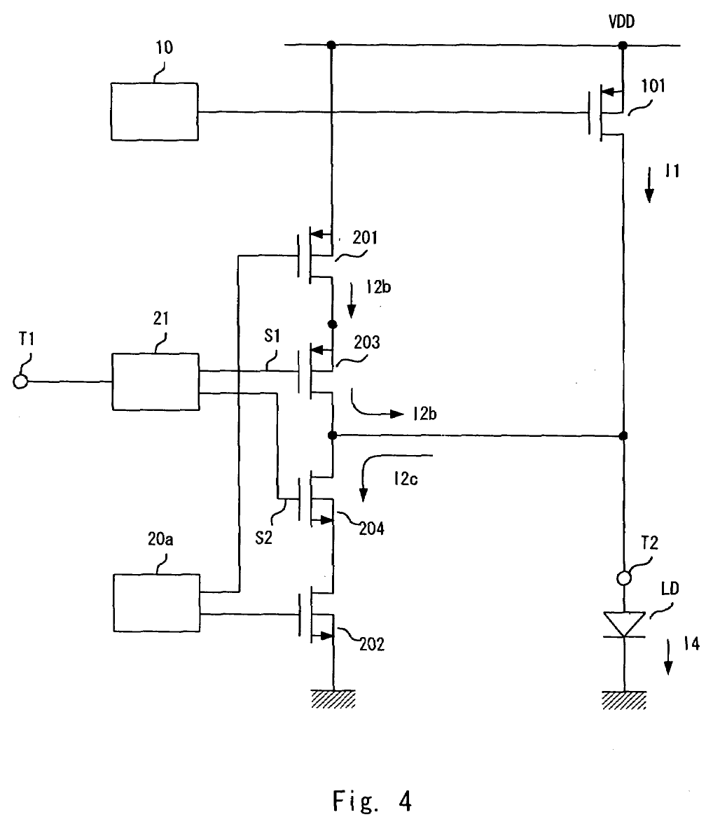

Referring then to FIG. 4, a laser diode driver according to a second embodiment of the present invention includes the DC current source 101, the first current setting circuit 10 which sets the current of the DC current source 101, the high frequency current source 201, the sink-side high frequency current source 202, a second current setting circuit 20a which is capable of setting the current of the source-side high frequency current source 201 and the current of the sink-side high frequency current source 202 to be different from each other, the first switching element 203, the second switching element 204, and the superposition controller 21 which turns ON/OFF the first switching element 203 and the second switching element 204. The second embodiment is different from the first embodiment in that the additional current source 301 connected in parallel with the source-side high frequency current source 201 and the third current setting circuit 30 for setting the current of the additional current source 301 are not provided, and the second current setting circuit has a different configuration, so that the current of the source-side high frequency current source 201 and the current of the sink-side high frequency current source 202 can be set different from each other. Although the circuit block diagram has a similar configuration as the laser diode driver of the related art described with reference to FIG. 9, the internal structure of the second current setting circuit is different. The second embodiment has the characteristic feature of setting the current of the source-side high frequency current source 201 and the current of the sink-side high frequency current source 202 so as to set different values from each other.

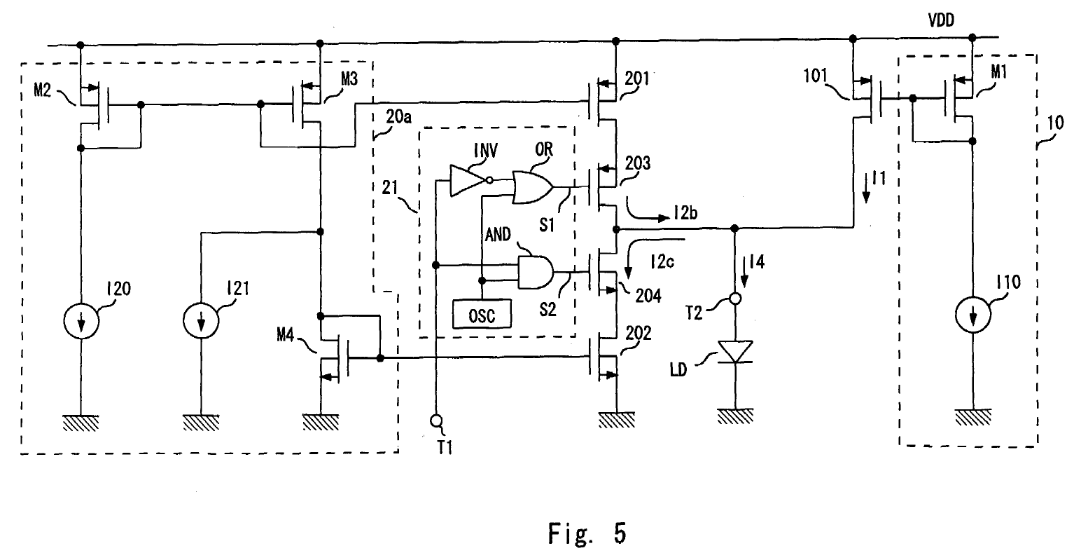

Referring then to FIG. 5 showing a detailed example of the circuit of FIG. 4, the configuration of the laser diode driver is described hereinafter. The laser diode driver according to the second embodiment of the invention has substantially the same configuration as the laser diode driver according to the first embodiment described above. However, they are different in that the additional current source 301 and the third current setting circuit 30 are not provided and that a superposition controller 20a includes a current source I21 having one end connected to the drain of the NMOS transistor M4 and the other end connected to the ground.

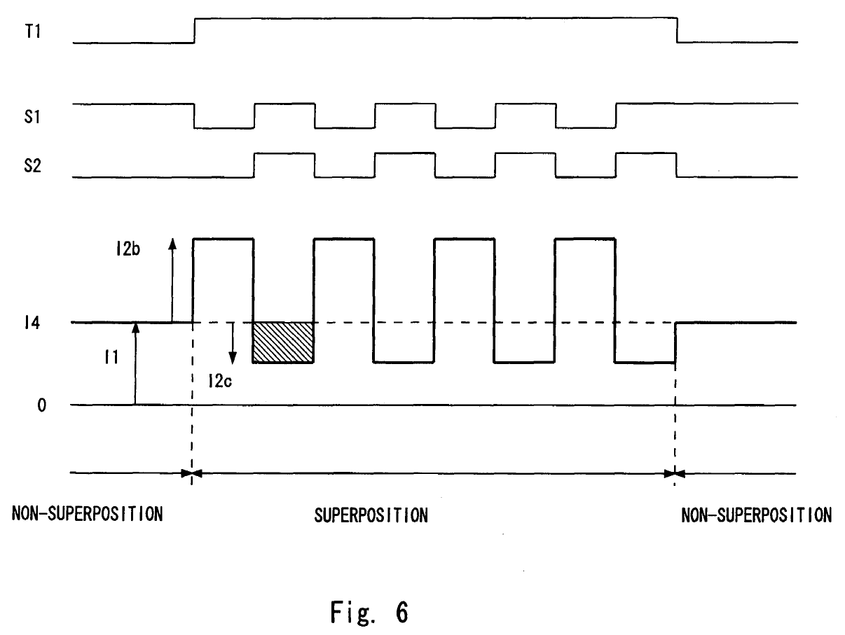

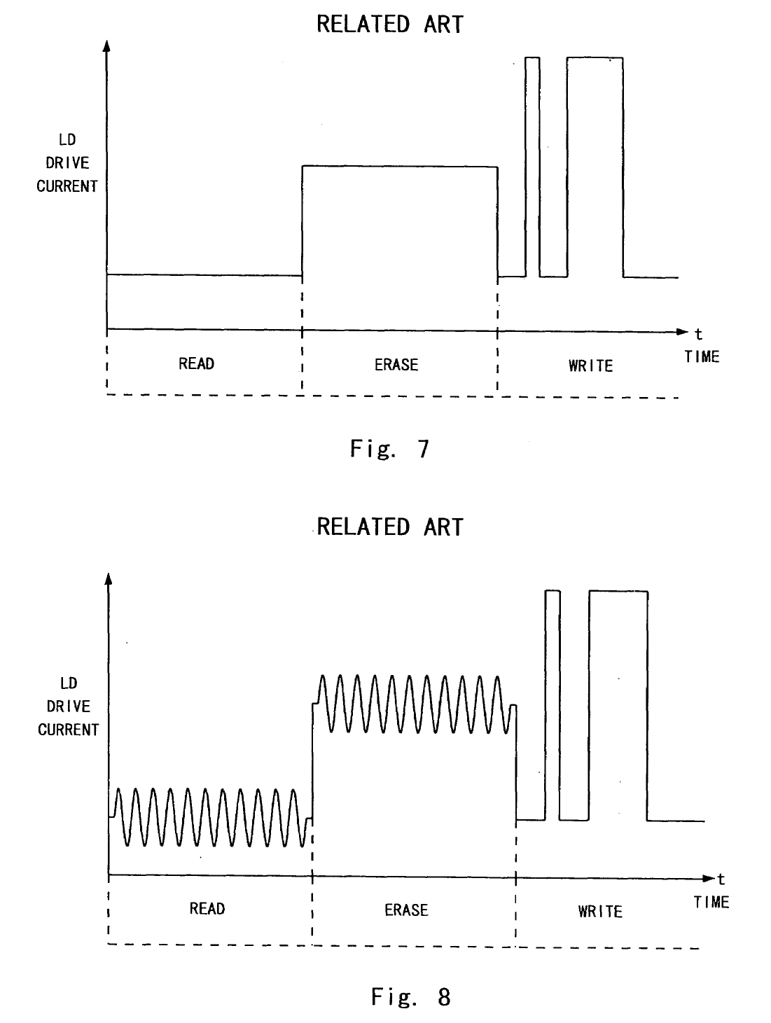

Referring further to FIGS. 5 and 6, the operation of the laser diode driver of this embodiment is described hereinbelow. The operation when the superposition control terminal T1 is L level is the same as that in the laser diode driver of the first embodiment. Specifically, the first switching element 203 and the second switching element 204 are both OFF, so that the DC current I1 in which the current flowing through the current source I10 is multiplied by the mirror ratio of the PMOS transistor M1 and the DC current source 101 is output from the output terminal T2, thereby performing the operation where no high frequency current is superposed.

The operation when the superposition control terminal T1 is H level is the same as that in the laser diode driver of the first embodiment. Specifically, the first switching element 203 and the second switching element 204 alternately turn ON and OFF.

When the first switching element 203 is ON, a sum of high frequency current I2b in which the current flowing through the current source I20 is multiplied by the mirror ratio of the PMOS transistor M2 and the source-side high frequency current source 201, and the DC current I1 is output from the output terminal T2. In this embodiment, the mirror ratio is set such that the current I2b is a sum of the current I2a and I3a described in the laser diode driver of the first embodiment. On the other hand, when the second switching element 204 is ON, the current in which the high frequency current I2c obtained by multiplying the current flowing through the current source I20 by the mirror ratio of the PMOS transistor M2 and the PMOS transistor M3, subtracting the current flowing through the current source I21 from the multiplied result, and further multiplying the subtracted result by the mirror ratio of the NMOS transistor M4 and the sink-side high frequency current source 202 is subtracted from the DC current I1 is output from the output terminal T2. In this embodiment, the current of the current source 21 and the mirror ratio are set such that the current I2c equals the current I2a described in the laser diode driver of the first embodiment. Consequently, in the operation where the high frequency current is superposed, the current that adds the DC current I1 with the high frequency current I2b on the source-side side and the current that subtracts the high frequency current I2c on the sink-side side from the DC current I1 are alternately output from the output terminal T2.

In the laser diode driver of this embodiment, the same current waveform as that of the laser diode driver of the first embodiment described with reference to FIG. 3 is obtained, and the portion corresponding to the useless electric power which does not contribute to the emission of the laser diode LD is indicated by the oblique line in FIG. 6. The high frequency current I2c which flows to the ground through the sink-side high frequency current source 202 of the opposite polarity to the current polarity of the DC current can be smaller by ½ of the additional current I3a than that in the laser diode driver described with reference to FIGS. 9 and 12 on condition that the amplitude of the entire high frequency current is the same. This enables the reduction of the useless electric power which does not contribute to the emission of the laser diode LD.

The laser diode driver of this embodiment can set the current of the source-side high frequency current source 201 and the current of the sink-side high frequency current source 202 to be different from each other. In this configuration, the laser diode including a DC current source for supplying DC current to the laser diode and a plurality of high frequency current sources for alternately superposing the high frequency current of the same polarity as the DC current and the high frequency current of the opposite polarity to the DC current onto the DC current enables the high frequency current of the opposite polarity to be smaller than the high frequency current of the same polarity. Consequently, if the amplitude of the high frequency current is the same, the high frequency current flowing to the ground through the sink-side high frequency current source of the opposite polarity from the DC current can be reduced, thereby providing the advantages of reducing the power consumption and suppressing the heating.

As described in the foregoing, in the laser diode driver according to the embodiments of the present invention, when superposing the high frequency current, the high frequency current of the opposite polarity can be smaller than the high frequency current of the same polarity. Thus, provided that the amplitude of the high frequency current is the same, the high frequency current flowing to the ground through the sink-side high frequency current source of the opposite polarity to the DC current can be reduced, thereby providing the advantages of reducing the power consumption and suppressing the heating.

Although the above embodiments are described in reference to the case of using a DC current source and a set of high frequency current sources, it is possible to prepare drivers respectively exclusive to CD system and DVD system and use a plurality of DC current sources or a plurality of sets of high frequency current sources by selection.

The present invention may be altered in various ways without departing from the scope of the invention. For example, it is possible to use transistors of the opposite conductivity type to those described in the above embodiments or a logic circuit which operates in the same manner.

It is apparent that the present invention is not limited to the above embodiment and it may be modified and changed without departing from the scope and spirit of the invention.

What is claimed is:

1. A laser diode driver comprising:
a DC current source supplying DC current to a laser diode; and
a plurality of high frequency current sources alternately superposing onto the DC current high frequency current of the same polarity as the DC current and high frequency current of an opposite polarity to the DC current,
wherein the high frequency current of the opposite polarity is smaller than the high frequency current of the same polarity.

2. The laser diode driver according to claim 1, wherein
the plurality of high frequency current sources include: a source-side high frequency current source connected between a node between the DC current source and the laser diode, and a power supply voltage; and a sink-side high frequency current source connected between the node between the DC current source and the laser diode, and a ground voltage, and
the laser diode driver further comprises an additional current source connected in parallel with the source-side high frequency current source.

3. The laser diode driver according to claim 2, wherein the source-side high frequency current source and the additional current source simultaneously turn ON and OFF by a common switching element.

4. The laser diode driver according to claim 1, wherein current of the sink-side high frequency current source is smaller than current of the source-side high frequency current source.

5. The laser diode driver according to claim 1, wherein
the plurality of high frequency current sources include: a source-side high frequency current source connected between a node between the DC current source and the laser diode, and a power supply voltage; and a sink-side high frequency current source connected between the node between the DC current source and the laser diode, and a ground voltage, and
the laser diode driver further comprises a current setting circuit capable of setting current of the source-side high frequency current source and current of the sink-side high frequency current source to a different value from each other.

6. The laser diode driver according to claim 5, wherein current of the sink-side high frequency current source is smaller than current of the source-side high frequency current source.

7. A laser diode driver comprising:
a DC current source supplying DC current to a laser diode;
a first high frequency current source generating high frequency current of the same polarity as the DC current; and
a second high frequency current source generating high frequency current of an opposite polarity to the DC current and being smaller than the high frequency current of the same polarity.

8. The laser diode driver according to claim 7, wherein the first and the second high frequency current sources alternately superpose onto the DC current the high frequency current of the same polarity and the high frequency current of the opposite polarity.

9. A laser diode driver comprising:
a first superposition path outputting high frequency current of a first polarity; and
a second superposition path outputting high frequency current of a second polarity,
wherein the high frequency current of the first polarity from the first superposition path and the high frequency current of the second polarity from the second superposition path are alternately superposed onto DC current of the first polarity from a DC current source,
an absolute value of the high frequency current of the second polarity is smaller than an absolute value of the high frequency current of the first polarity, and
no current flows from the first superposition path to the second superposition path during the superposition.

10. The laser diode driver according to claim 9, further comprising:
a source-side high frequency current source;
a sink-side high frequency current source; and
an additional current source,
wherein high frequency current from the source-side high frequency current source and additional current from the additional current source are supplied to the first superposition path,
high frequency current from the sink-side high frequency current source is supplied to the second superposition path, and
an absolute value of the high frequency current from the source-side high frequency current source and an absolute value of the high frequency current from the sink-side high frequency current source are equal.

11. The laser diode driver according to claim 9, further comprising:
a source-side high frequency current source; and
a sink-side high frequency current source,
wherein high frequency current from the source-side high frequency current source is supplied to the first superposition path,
high frequency current from the sink-side high frequency current source is supplied to the second superposition path, and
an absolute value of the high frequency current from the sink-side high frequency current source is smaller than an absolute value of the high frequency current from the source-side high frequency current source.

12. The laser diode driver according to claim 10, wherein
the first superposition path is composed of a first switching element,
the second superposition path is composed of a second switching element, and
the first switching element and the second switching element alternately turn ON and OFF during the superposition.
